(19) United States
(12) Patent Application Publication
(10) Pub. No.: US 2008/0199650 A1
(43) Pub. Date: Aug. 21, 2008

(54) Multifunctional and modular combined doormat

(75) Inventor: Larry Yaw, Taichung (TW)

Correspondence Address: BRUCE H. TROXELL;SUITE 1404, 5205 LEESBURG PIKE, FALLS CHURCH, VA, 22041, US

(73) Assignee: Taicang All Mats Plastic Industry Co., Ltd.

(21) Appl. No.: 11/708,711

(22) Filed: Feb. 21, 2007

(51) Int. Cl. B32B 3/02

(52) U.S. Cl. 428/88

(57) ABSTRACT

A multifunctional and modular combined doormat includes a basic mat and a functional mat. The basic mat has two abutting edges of its topside respectively fixed with numerous positioning lugs spaced apart equidistantly and respectively bored with a positioning hole, and the other two abutting edges of its underside respectively disposed with numerous position projections spaced apart equidistantly and corresponding with the positioning holes. Two or more basic mats can be combined together by mutual engagement of the positioning holes and the position projections. The functional mat is assembled on the basic mat, having special functions. Thus, a multifunctional and modular combined doormat is made by combining the basic mats with the functional mats.

### BACKGROUND OF THE INVENTION

1. Field of the Invention

This invention relates to a doormat, particularly to one made by combining acting mats of different functions on plural basic mats, able to be freely combined and changed to make up a multifunctional and modular doormat according to practical needs.

2. Description of the Prior Art

Generally, a home, a store, a restaurant or a company has its entrance or vestibule paved with a large-sized doormat for cleaning shoes of mud and dirt to avoid soiling and wetting the indoor floor and multiplying bacteria in the room and prevent people from slipping and falling. A conventional doormat 1, as shown in FIG. 1, includes a basic body 2 made of plastic and having its upper surface bored with numerous recessed slots 3 so that people, before entering a room, can scrape their shoes on the slotted surface of the doormat 1 to remove soil and grime from the shoes sole so as to keep the indoor floor clean. However, although disposed with recessed slots 3 in the topside for cleaning shoes of mud and dirt, the conventional doormat cannot effectively scrape and remove the water on the shoe sole, nor does it have other additional functions, thus improper to be paved on any comparatively large ground for use.

### SUMMARY OF THE INVENTION

This invention is advised to offer a multi functional and modular combined doormat including a basic mat and a functional mat. The basic mat has two abutting edges of its topside respectively fixed thereon with plenty of positioning lugs spaced apart equidistantly and respectively bored with a positioning hole, and the other two abutting edges of its underside respectively secured thereon with lots of position projecting members spaced apart equidistantly and corresponding with the positioning holes. By so designing, two or more basic mats can be combined together by mutual engagement of the positioning holes and the position projecting members. The functional mat to be assembled on the basic mat is composed of a bottom layer to be secured on the basic mat, and a functional layer having special function fixed on the bottom layer. The basic mats can be combined thereon with various functional mats made of different materials by supersonic-wave hot pressing and welding or by gluing to make up a multifunctional and modular doormat. The multifunctional and modular combined doormat of this invention can be freely combined and changed according to practical needs.

### BRIEF DESCRIPTION OF DRAWINGS

This invention will be better understood by referring to the accompanying drawings, wherein:

FIG. 1 is a perspective view of a conventional doormat;

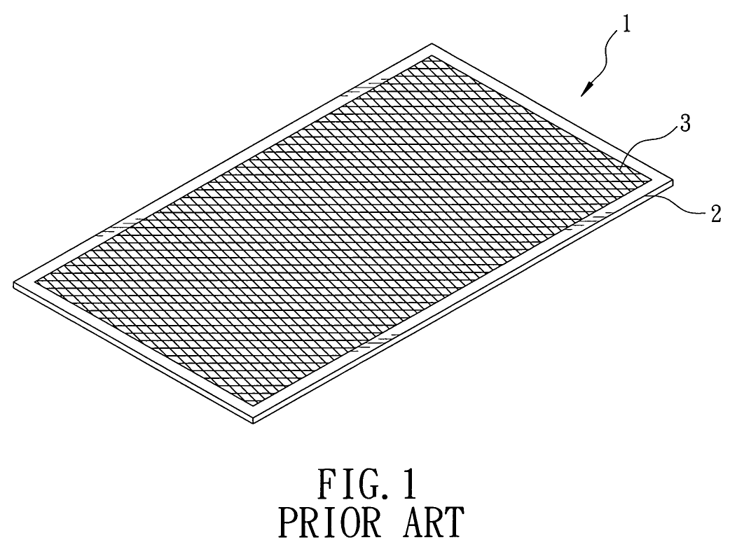

FIG. 2 is a perspective view of a first preferred embodiment of the topside of the basic mat of a combined doormat in the present invention;

FIG. 3 is a perspective view of the first preferred embodiment of the underside of the basic mat of the combined doormat in the present invention;

FIG. 4 is a perspective view of the first preferred embodiment of the combined doormat in the present invention;

FIG. 5 is an upper view of a second preferred embodiment of a combined doormat in the present invention;

FIG. 6 is a cross-sectional view of the second preferred embodiment of the combined doormat in the present invention;

FIG. 7 is an upper view of a third preferred embodiment of a combined doormat in the present invention;

FIG. 8 is an upper view of a fourth preferred embodiment of a combined doormat in the present invention; and

FIG. 9 is an upper view of the combined doormat made by having different functional mats fixed on plural basic mats in the present invention.

### DETAILED DESCRIPTION OF THE PREFERRED EMBODIMENT

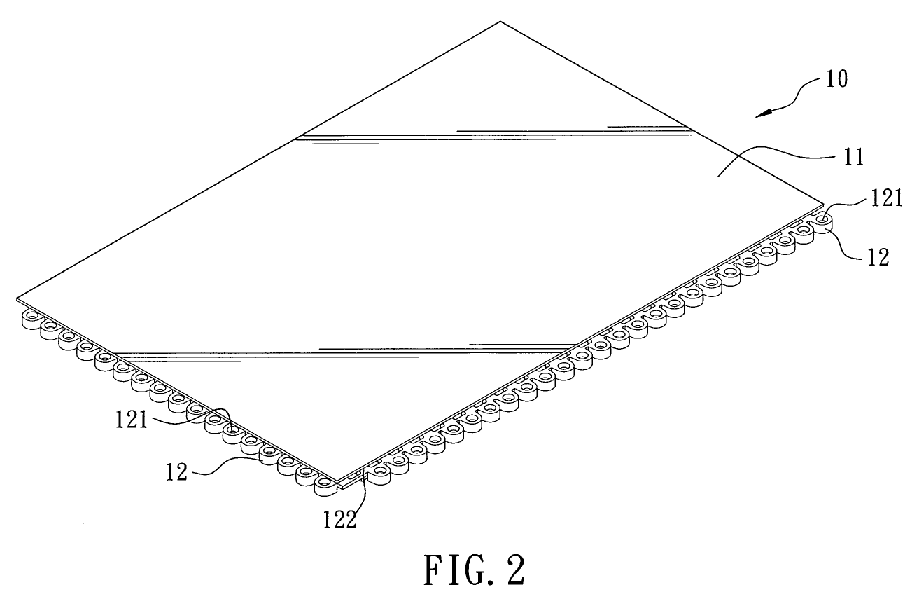

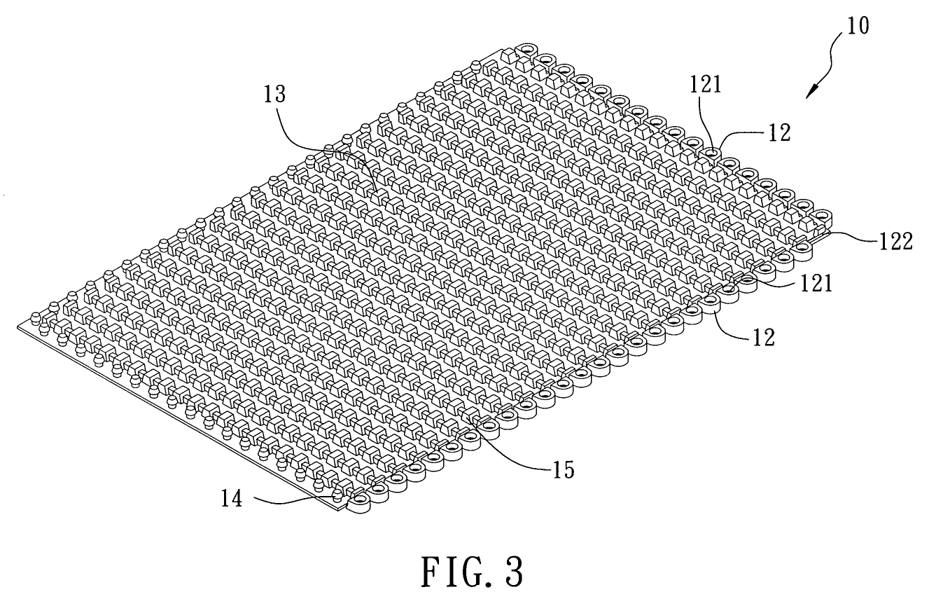

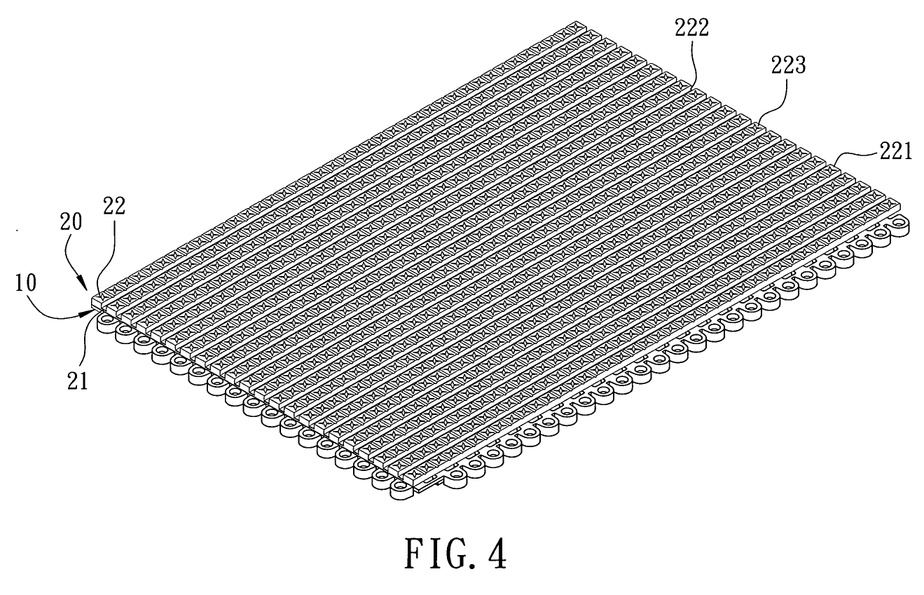

A first preferred embodiment of a multifunctional and modular combined doormat in the present invention, as shown in FIGS. 2, 3 and 4, includes a basic mat 10 and a functional mat 20 combined together.

The basic mat 10 is a rectangular body made of flexible plastic able to be cut. The basic mat 10 has two abutting edges of its topside 11 respectively disposed with lots of positioning lugs 12 spaced apart equidistantly and respectively bored with a positioning hole 121, and the other two abutting edges of its underside respectively provided with plenty of position projections 14 spaced apart equidistantly and corresponding with the positioning holes 121 of the positioning lugs 12. Thus, two or more basic mats 10 can be combined together by mutual engagement of the position projections 14 and the positioning holes 121 of the positioning lugs 12. Further, the basic mat 10 has its underside fixed with plural rows of lengthwise slip-resisting projections 15 spaced apart equidistantly for preventing the basic mat 10 from slipping.

The functional mat 20 to be fixed on the basic mat 10 consists of a bottom layer 21 and a functional layer 22. The bottom layer 21 is a rectangular sheet made of the same plastic as the basic mat 10 and having a size approximately equivalent to that of the basic mat 10, so that the functional mat 20 can be secured on the basic mat 10 by means of its bottom layer 21 through high frequency welding or by gluing. The functional layer 22 fixed on the bottom layer 21 has its upper side disposed with lots of parallel rib bars 221 respectively formed with plenty of X-shaped projecting streaks 223 on the topside, and plural lengthwise grooves 222 respectively formed between every two ribs 221. Thus, provided with the ribs bars 221 and the grooves 222, the functional mat 20 not only can scrape coarse sand from shoe sole, but can resist great pressure as well.

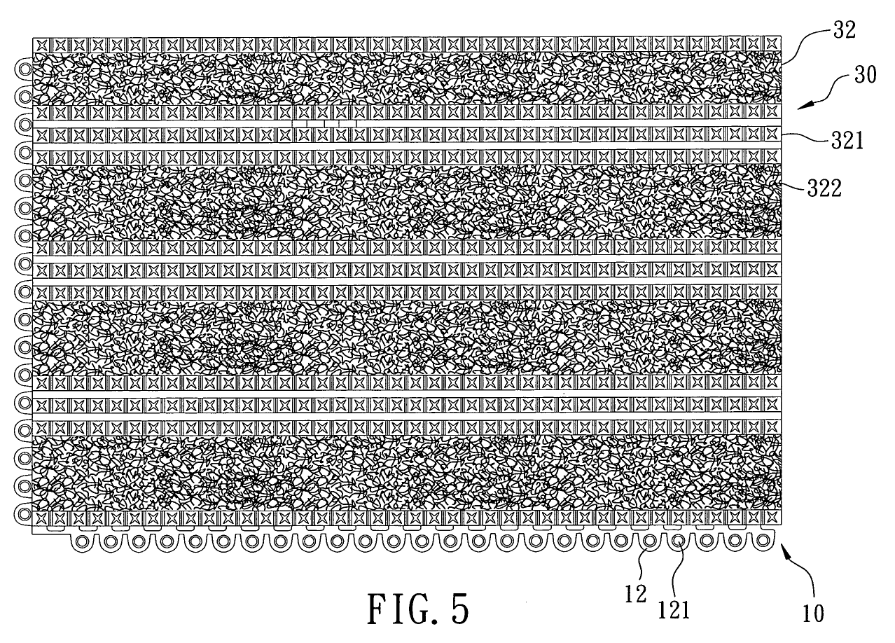

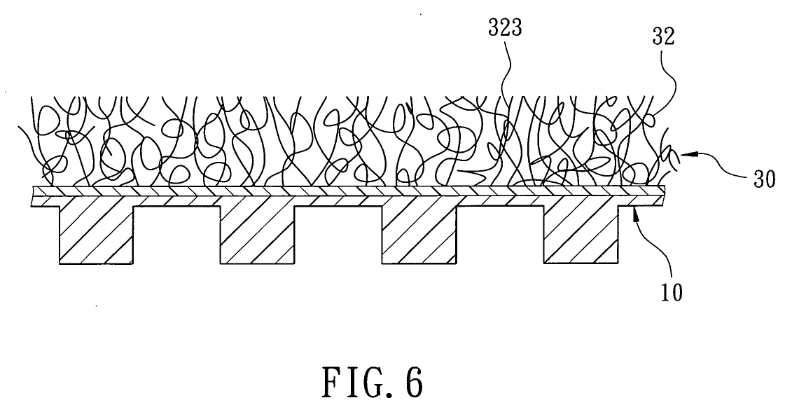

A second preferred embodiment of a multifunctional and modular combined doormat in the present invention, as shown in FIGS. 5 and 6, includes a basic mat 10 and a functional mat 30. The basic mat 10 is the same as that of the first preferred embodiment in material and structure. The functional amt 30 consists of a functional layer 32 disposed thereon with a plurality of parallel lengthwise ribs 321 and accommodating grooves 322 respectively formed between two adjacent ribs 321. Each accommodating groove 322 is fitted therein with a plastic-thread layer 323 made of numerous plastic threads, which are entangled loosely with one another and severed to let the upper surface of the plastic-thread layer 323 filled with needle-shaped plastic threads. By so designing, fine sand and mud stuck on shoe sole can be scraped off by means of the plastic-thread layer 323 and the frictional action produced by the needle-shaped plastic threads.

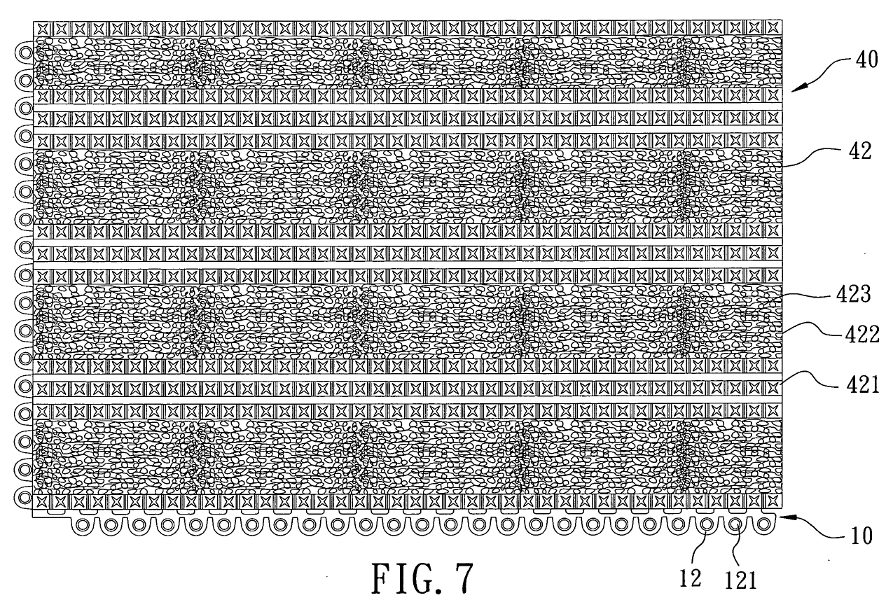

A third preferred embodiment of a multifunctional and modular combined doormat in the present invention, as shown in FIG. 7, includes a basic mat 10 and a functional mat 40. The functional mat 40 is made of the same material and has the same structure as that described in the first preferred embodiment. The functional mat 40 contains a functional layer 42 provided with plural lengthwise parallel ribs 421 and lengthwise accommodating grooves 422 respectively formed between two adjacent ribs 421. Each accommodating groove 422 is fitted therein with a water-absorbing strip 423 made of non-woven fabric, nylon-silk fabric or natural fiber, such as cotton, linen, coir and the like. Thus, by action of water absorption and friction produced by the water-absorbing strips 423, the functional mat 40 is able to scrape off mud and absorb filthy water from shoe soles with excellent effect.

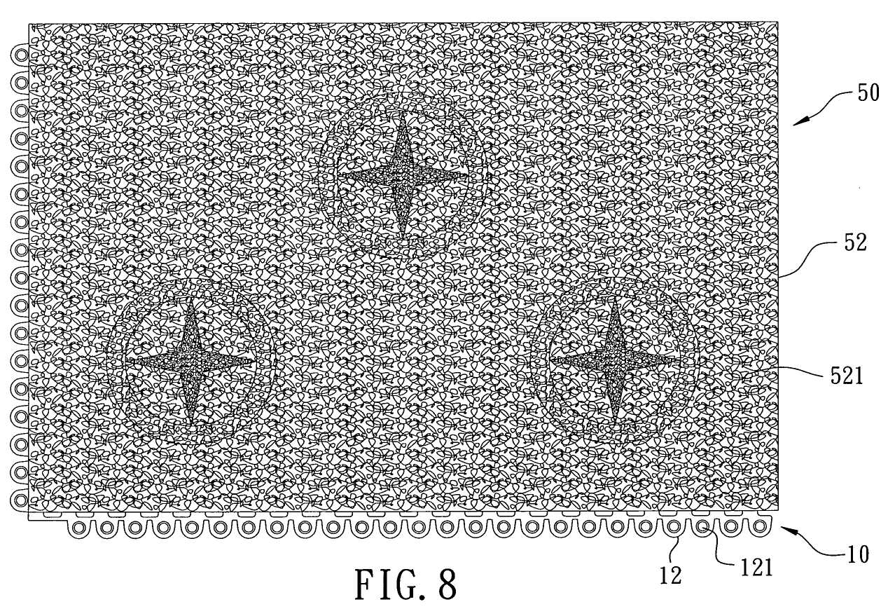

A fourth preferred embodiment of a multifunctional and modular combined doormat in the present invention, as shown in FIG. 8, includes the same basic mat 10 as that described in the first preferred embodiment and a functional mat 50 with a functional layer 52. The functional layer 52 of the functional mat 50 is made of numerous annular plastic threads 521 irregularly entangled loosely with one another. The plastic threads 521 can be formed with two or more kinds of colors, and then cut and put together anew to make up decorative patterns or characters. Thus, aside from having excellent effect in scraping fine sand from shoe sole, the acting mat 50 can be employed as advertising means.

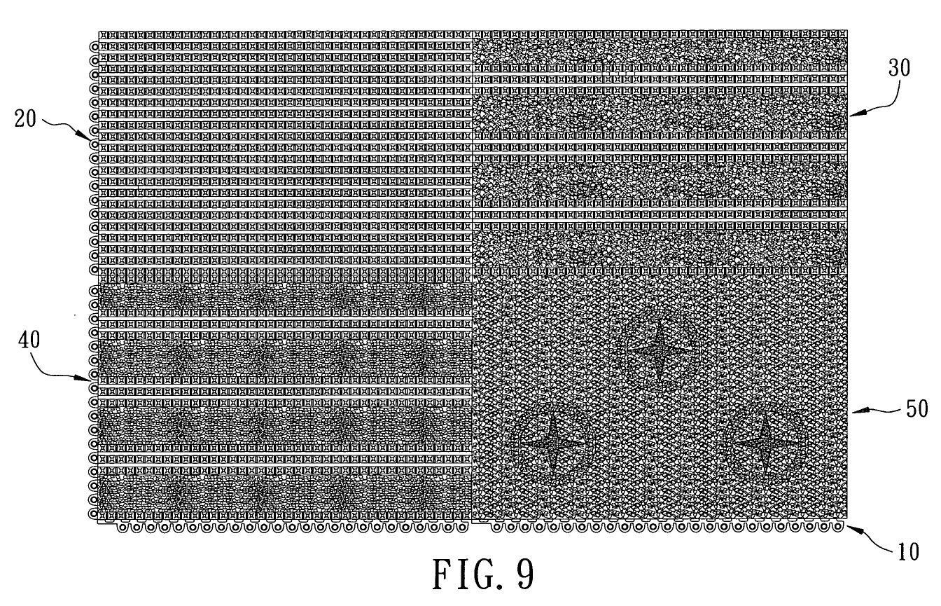

To combine the doormat units of this invention together for making up a multifunctional and modular doormat, as shown in FIG. 9, simply have the positioning holes 121 of the positioning lugs 12 of one basic mat 10 respectively and correspondingly engaged with the position projecting members 14 of another basic mat 10 and then secure the functional mat 20, 30, 40 or (and) 50 on the basic mats 10.

As can be understood from the above description, this invention has some advantages described as follows.

1. Two or more basic mats of this invention can be combined together by mutual engagement of the positioning holes of one basic mat and the position projections of another basic mat, easy and quick in assembly.

2. Various functional mats of different functions can firmly be assembled on the basic mats by supersonic-wave hot pressing and welding or by gluing to make up a large-sized and multifunctional doormat.

3. Although diversified in structure, the functional mats of this invention can be respectively combined with the basic mats by supersonic-wave hot pressing and welding or by gluing, having modular effect.

4. The basic mat and the functional mat are made of flexible plastic; therefore, after they are combined together to make up a doormat, the unnecessary outer edge of the doormat can be cut out to elevate beauty of an external appearance.

While the preferred embodiment of the invention has been described above, it will be recognized and understood that various modifications may be made therein and the appended claims are intended to cover all such modifications that may fall within the spirit and scope of the invention.

I claim:

1. A multifunctional and modular combined doormat comprising:
a basic mat formed integral of plastic and shaped rectangular, said basic mat having two abutting edges of its topside respectively disposed with lots of positioning lugs spaced apart equidistantly, each said positioning lug bored with a positioning hole, said basic mat having the other two abutting edges of its underside respectively formed with many position projections spaced apart equidistantly and corresponding with said positioning holes, two said basic mats able to be combined together by mutual engagement of said positioning holes and said position projections; and
a functional mat assembled on said basic mat, said functional mat composed of a bottom layer and a functional layer, said bottom layer made of plastic and shaped rectangular, said bottom layer having a size approximately equivalent to that of said basic mat, said functional mat firmly assembled on said basic mat by means of said bottom layer, said functional layer having special function, said basic mats and said function mats able to be combined with each other to make up a doormat having multiple function and modular structure.

2. The multifunctional and modular combined doormat as claimed in claim 1, wherein said functional layer of said acting mat is disposed thereon with numerous parallel ribs and grooves, said grooves respectively formed between two adjacent said ribs.

3. The multifunctional and modular combined doormat as claimed in claim 1, wherein said ribs of said functional layer are respectively provided thereon with several X-shaped projecting streaks.

4. The multifunctional and modular combined doormat as claimed in claim 1, wherein said functional layer of said functional mat is disposed with plenty of parallel ribs and accommodating grooves respectively formed between two adjacent said ribs, said accommodating grooves respectively fitted therein with a plastic-thread layer, said plastic-thread layer made of numerous plastic threads entangled loosely with one another.

5. The multifunctional and modular combined doormat as claimed in claim 4, wherein said plastic threads of said plastic-thread layer can be severed to let said plastic-thread layer formed with a topside filled of needle-shaped plastic threads.

6. The multifunctional and modular combined doormat as claimed in claim 1, wherein said functional layer of said functional mat is provided with a plurality of parallel ribs and accommodating grooves respectively positioned between two adjacent said rib bars, said accommodating grooves respectively inserted therein with a water-absorbing strip.

7. The multifunctional and modular combined doormat as claimed in claim 1, wherein said functional layer of said functional mat is made of numerous annular plastic threads irregularly entangled loosely with one another.

8. The multifunctional and modular combined doormat as claimed in claim 7, wherein said plastic threads of said functional layer can be formed with two or more kinds of colors, and cut and put together a new to form decorative patterns or characters used as advertising means.
